(19) United States
(12) Patent Application Publication
(10) Pub. No.: US 2011/0218880 A1
(43) Pub. Date: Sep. 8, 2011

(54) SYSTEMS AND METHODS USING MOBILE DEVICE IN PAYMENT TRANSACTION

(76) Inventors: Ayman Hammad, Pleasanton, CA (US); Simon Hurry, Foster City, CA (US)

(21) Appl. No.: 13/039,102

(22) Filed: Mar. 2, 2011

Related U.S. Application Data
(60) Provisional application No. 61/310,213, filed on Mar. 3, 2010.

(51) Int. Cl. G06Q 30/00

(52) U.S. Cl. 705/26.41

(57) ABSTRACT

Systems and methods for performing a payment transaction are disclosed. In the embodiments of the invention, a mobile device is used by a user to receive an identifier associated with a piece of merchandise or a service from a merchant. The user then initiates a payment transaction with a remote payment server computer hosted by a third party processor. Upon completion of the payment transaction, the remote payment server computer notifies the user and the merchant that a payment has been made. The merchant then provide the merchandise or the service to the user. In the embodiments of the invention, a payment transaction is performed without exposing or disclosing financial account information of the user to the merchant.

### CROSS-REFERENCES TO RELATED APPLICATIONS

The present application claims benefit under 35 U.S.C. §119(e) of U.S. Provisional Patent Application No. 61/310,213, entitled “System Using Dynamic Verification Value and Payment Host Site”, filed Mar. 3, 2010, the entire disclosure of which is incorporated herein by reference in its entirety for all purposes.

### BACKGROUND

For merchants, accepting credit and debit card based payments can provide flexibility and more revenue. Merchants that accept credit and debit cards typically establish a business relationship with an acquirer. They must also purchase and install a POS (point of service) device so that they can accept credit and debit cards. In the case of small, mobile, and seasonal merchants (e.g., food trucks and flea market vendors), it may be too expensive or inconvenient for such merchants to acquire traditional POS terminals.

An additional problem to be addressed is the problem of trust between the merchant and the consumer. Even assuming for the moment that small, mobile, or seasonal merchants are able to acquire POS terminals, consumers may not trust them and may be afraid of exposing their financial information to them. Typically, with small merchants there is no pre-existing relationship with the consumers, and as a result, the level of trust is not as high as the established larger merchants. For example, a consumer will typically have a greater degree of trust in an established merchant such as McDonald's®, rather than a flea market vendor that the consumer does not know.

Therefore, there is a need for systems and methods that would allow consumers to use their credit and debit cards with small merchants without having to disclose their financial information directly to the merchants. Also, there is a need for systems and methods that would allow small and in some cases large merchants accept credit and debit cards without having to acquire and install traditional POS terminals.

Embodiments of the invention address these and other problems, individually and collectively.

### BRIEF SUMMARY

Embodiments of the invention disclosed herein include systems and methods for making electronic payments to a merchant or a service provider through a remote payment server computer operated by a third party entity, without disclosing any financial information and account data to the merchant or the service provider.

One embodiment of the invention is directed to a method comprising receiving an identifier at a mobile device of a user at a first location, communicating with a remote payment server computer at a second location using the mobile device, and providing the identifier to the remote payment server computer. The identifier may be associated with merchandise or a service offered by a merchant.

Another embodiment of the invention is directed to an identifier which is in the form of computer-readable data stored in a near-field merchandise identifier element which may be attached to merchandise. The user can use a near-field enabled mobile device to retrieve the identifier (computer-readable data) from the merchandise identifier element. The identifier may include a merchant ID and a merchandise ID. The merchant ID may be used to identify a particular piece of merchandise and the merchant ID may be used to identify a particular merchant.

Another embodiment of the invention is directed to an identifier which can be in the form of an image shown on a television display or the like.

Another embodiment of the invention is directed to an identifier which can be in the form of human-readable data displayed on a merchandise identifier element attached to merchandise. The identifier may include a merchant ID and a merchandise ID.

Another embodiment of the invention is directed to a mobile device being capable of accessing a catalog, using the identifier, including a virtual equivalent of merchandise associated with a merchant.

Another embodiment of the invention is directed to receiving an identifier from a mobile device of a user, identifying a recipient of a payment using the identifier, performing a payment transaction on behalf of the recipient of the payment and notifying the recipient of the payment that a payment has been made. The identifier is provided by a merchant to the user, and the merchant is the recipient of the payment.

Another aspect of an embodiment of the invention is directed to a method comprising generating an authorization request message for a payment associated with an account of the user, sending the authorization request message to an acquirer, and receiving authorization response message from the acquirer.

Another aspect of an embodiment of the invention is directed to a method comprising proving an identifier to a user, receiving a notification from a remote payment server computer that a payment has been made by the user for a good or a service associated with the identifier, and presenting a good or a service for which the payment was made to the user.

Another aspect of an embodiment of the invention is directed to a payment transaction where the user does not provide any financial data associated with the account data of the user to a merchant.

These and other embodiments of the invention are described in further detail below.

### BRIEF DESCRIPTION OF THE DRAWINGS

FIG. 1 shows a block diagram of a system, according to an embodiment of the invention.

FIG. 2 shows a block diagram of a payment server computer system, according to an embodiment of the invention.

FIG. 3 illustrates a flowchart describing the steps involved in establishing communication between a merchant and a payment server computer, according to an embodiment of the invention.

FIG. 4 illustrates a flowchart describing methods according to embodiments of the invention.

FIGS. 5-10 show steps involved in the process of purchasing merchandise from the viewpoint of a user, according to embodiments of the invention.

FIG. 11 illustrates a flowchart describing methods according to embodiments of the invention.

FIGS. 12-18 show steps involved in the process of purchasing merchandise from the viewpoint of a user, according to embodiments of the invention.

FIG. 19 shows a block diagram of a computer apparatus according to an embodiment of the invention.

### DETAILED DESCRIPTION

Embodiments of the invention disclosed herein include systems and methods for performing an electronic transaction (e.g., a payment transaction), by allowing a user to send his account information (e.g., payment account data such as an account number, expiration date, etc.) to a third party processor via a payment host site (e.g., a payment website), and without requiring the use of a merchant's POS terminal to initiate a payment transaction. Embodiments of the invention allow a merchant to accept credit and debit cards from users without the need to acquire a POS terminal.

Before describing specific embodiments of the invention, some descriptions of terms are provided below.

As used herein, an “authorization request message” may be a message that includes an issuer account identifier. The issuer account identifier may be the card data associated with a payment card. The authorization request message may request that an issuer of the payment card authorize a transaction. An authorization request message according to an embodiment of the invention may comply with ISO 8583, which is a standard for systems that exchange electronic transactions made by cardholders using payment cards. In embodiments of the invention, an authorization request message may include, among other data, a Primary Account Number (PAN) and expiration date associated with the portable consumer device (e.g. credit/debit card) of the user, amount of the transaction (which may be any type and form of a medium of exchange such a money or points), and identification of a merchant (e.g. merchant ID). Typically, an authorization request message is generated by a server computer (if the transaction is an e-commerce transaction) or a Point of Sale (POS) device (if the transaction is a brick and mortar type transaction) and is sent to an issuer via a payment processing network and an acquirer.

As used herein, “account information” may include a numerical or alpha-numerical values associated with an account of a user (consumer) issued by an issuer. Account information may also refer to a numerical or alpha-numerical value associated with a portable consumer device (e.g. debit/credit card) of the user. Account information may be used to locate a financial account of a user, generate a request to withdraw funds, purchase goods or services and perform any type of financial transaction. If a payment card is associated with an account, the account information may include “card data” such as an account number associated with the card, an expiration date associated with the card, verification values associated with the card, etc.

As used herein, an “identifier” may include computer-readable data that can identify something (e.g., an object, merchant, organization, service, etc.). An identifier may include information such as a merchant ID and/or the merchandise ID. In some embodiments, an identifier may be used to identify recipient of a payment. An identifier may also be associated with a service, provided by a service provider or a merchant, in exchange for a fee.

As used herein, “merchandise identifier element” may include a physical device coupled with a piece of merchandise. If it is in the form of a physical device, it can store computer-readable data associated with the merchandise such as merchandise ID, merchant ID, price of the merchandise, etc. A “merchant sticker” with a code may be an example of a merchandise identifier. A merchandise identifier element may also refer to a human-readable tag attached to merchandise. It can display identifying information about the merchandise (i.e. merchandise ID) and/or the merchant (i.e. merchant ID).

As used herein “dynamic verification value” (e.g., a dynamic device verification value, a dynamic card verification value, and a dCVV2 value) can refer to a value that can be used to verify that a transaction (and in some cases a portable consumer device used to conduct a transaction) is authentic. It may be a numeric or alpha-numeric value that is generated by an algorithm (e.g. encryption algorithm).

As used herein a “computer readable medium” or “computer readable storage medium” is typically a storage medium such a hard disk or any suitable type of data storage medium capable of storing data such as program codes. A computer readable medium may be embodied by one or more data storage devices.

As used herein, a “server computer” is typically a powerful computer or cluster of computers. For example, the server computer can be a large mainframe, a minicomputer cluster, or a group of servers functioning as a unit. In one example, the server computer may be a database server coupled to a Web server.

As used herein, a “near-field communication device” can be any suitable device that can allow for communication between devices. Such communication may use any suitable optical and/or electrical communication protocol. RF and IR transmissions may be examples of near field communication mechanisms. Typically, near field communications devices communicate within a range of less than 5, 2, 1, ½ and ¼ feet, but cannot communicate outside of such ranges.

In the embodiments of the invention, a user receives an identifier at his mobile device from a merchant at a first location. The first location may be the merchant's store or a location from which the merchant engages in commercial activity. In one embodiment, the identifier is in the form of computer-readable data stored in a near-field enabled merchandise identifier element.

In some embodiments, the merchandise identifier element may be a device (e.g., a tag) attached to merchandise. The merchandise identifier element may include a memory, antenna and processor. The identifier is stored in the memory and can be wirelessly transmitted to a mobile device (e.g. a mobile phone) used by the user. The identifier may be a string of numeric and/or alpha-numeric data and may include a merchant ID associated with the merchant and a merchandise ID associated with merchandise. Stated differently, the merchandise identifier element, can include a merchant ID and a merchandise ID, and such IDs can be in the form of a data string.

In one example, the user may go to a merchant store to buy a piece of merchandise such as a laptop computer. The merchandise may have a merchandise identifier element such as a near-field enabled tag attached to it. The user uses his near-field enabled mobile device to receive an identifier stored in the tag. This is performed via a near-field communication device that may be attached to or embedded in the mobile device. In an exemplary operation, the user presents his mobile device to the tag and waits for the identifier to be transmitted to his mobile device.

When the user receives the identifier from the tag attached to the merchandise, using his mobile device, he then communicates with a remote payment server computer at a second location by initiating a connection with a remote payment server computer. The mobile device may communicate with the payment server computer using a web browser or a mobile application on the mobile device. The mobile device of the user then provides the identifier that is provided by the merchant to the user (i.e. provided via the tag attached to the merchandise) to the remote payment server computer. The payment server computer then displays via the web browser, for example, various information (e.g., a picture, the price, a description, warranty information, reviews, etc.) about the merchandise.

The identifier may be associated with a piece particular merchandise and/or a particular merchant. Using the identifier, the remote payment server computer accesses a database that stores the above information associated with the merchandise at the merchant location. The remote payment server computer also identifies, using the identifier, a recipient of a payment from the user which may be the merchant or another entity.

When the user reviews the merchandise information on his mobile device, he can then pay for the merchandise transaction. In one embodiment, the user can send his account information (e.g. debit/credit card data) from his mobile device to the remote payment server in any suitable manner. In one embodiment, the user can hold a payment card such as a contactless credit/debit card close to his mobile device. Card data from the payment card can then be wirelessly transmitted via a contactless element in the payment card to the near-field communication device of the mobile device. In another embodiment, the user can manually type his card data into a payment page hosted by the remote payment server computer. In yet another embodiment, the user can use a payment application on his mobile device (which stores the card data of a payment card used by the user) to send the card data to the remote payment server computer. In yet another embodiment, the user can use a server side wallet that contains the account information of the user. The user can communicate with another entity to provide the account information to the payment server computer or can direct the payment server computer to retrieve the account information from another entity which is in possession of the account information of the user.

The remote payment server computer can then generate an authorization request message for a payment associated with an account of the user using the card data, the data from the identifier, etc., and the authorization request message may then be forwarded to an acquirer. The acquirer may then send the authorization request message to a payment processing network which in turn sends it to an issuer associated with an account of the user. The issuer generates an authorization response message which indicates whether the payment transaction is approved or not. The authorization response message will be then sent back to the remote payment server computer.

When the remote payment server computer receives the authorization response message, it can then send a notification to the recipient of the payment (which may be the merchant) that a payment has been made. A notification may also be sent to the mobile device of the user. The notification is received in the mobile device upon completion of the payment transaction and may include a reference number, as a proof of payment, to be presented to the merchant.

When the merchant receives the notification from the payment server computer, the user will be presented with the merchandise that he purchased. In this payment transaction, the user does not provide any account information (e.g. Primary Account Number (PAN) and expiration date of a payment card) to the merchant. Also, no account information associated with the user is received from the remote payment server computer by the merchant.

In some embodiments of the invention, the identifier may be in the form of a human-readable data displayed on a merchandise identifier element attached to merchandise. The identifier may be one or more numeric or alpha-numeric strings used to identify a particular piece of merchandise associated with a particular merchant.

For example, the identifier may be the form of a printed number on a tag. The printed number may be a merchandise ID and/or a merchant ID. When the user communicates with the remote payment server computer, he can enter the merchant ID and/or the merchandise ID in a payment page hosted by the remote payment server computer.

Similar to the process described above, the remote payment server computer may use the merchant ID and/or the merchandise ID to display the information associated with the merchandise on the mobile device of the user. The user may then follow the same process to pay for the merchandise.

In some embodiments, the identifier may be in the form of an address (e.g., a URL address of a web site) that the user can use to access. The site associated with the address may provide for a catalog including virtual equivalents of merchandise in the merchant's store. For example, the user may receive a website address from the merchant and log into the website using his mobile device. The user can then browse through the virtual equivalent of the merchandise sold by the merchant. The user can select a piece of merchandise and pay for it using the above-described process.

In some embodiments, the identifier may be shown on a television display, and the user may take a picture of the identifier with his mobile device. The identifier may be part of a digital image captured by the mobile device. The digital image may then be sent to the remote payment server computer which analyzes the image to identify the merchandise and/or the merchant. The remote payment server compute then displays the information related to the merchandise on the mobile device of the user, and the user may follow the above-described process to make a payment and purchase the merchandise.

In some embodiments of the invention, the mobile device communicates with the remote payment server computer using a text message. The user can send a text message including an identifier to the remote payment server computer. The user may have previously enrolled his payment card with the remote payment server computer. Upon receipt of the text message, the remote payment server computer can locate the user's account information. The remote payment server computer can then send a text message with some information associated with the merchandise that the user is interested in purchasing. The user can then send a reply confirming the payment.

In the embodiments of the invention, the mobile device may communicate with the remote payment server computer via a mobile application, and the payment transaction can be initiated by a payment application on the mobile device of the user.

In the embodiments of the invention, the system and methods used to perform the above-described processes, may also be used for the purchase of service provided by a service provide or a merchant. For example, an identifier may be associated with a service, and the user can make a payment for the service via the above methods.

I. Systems

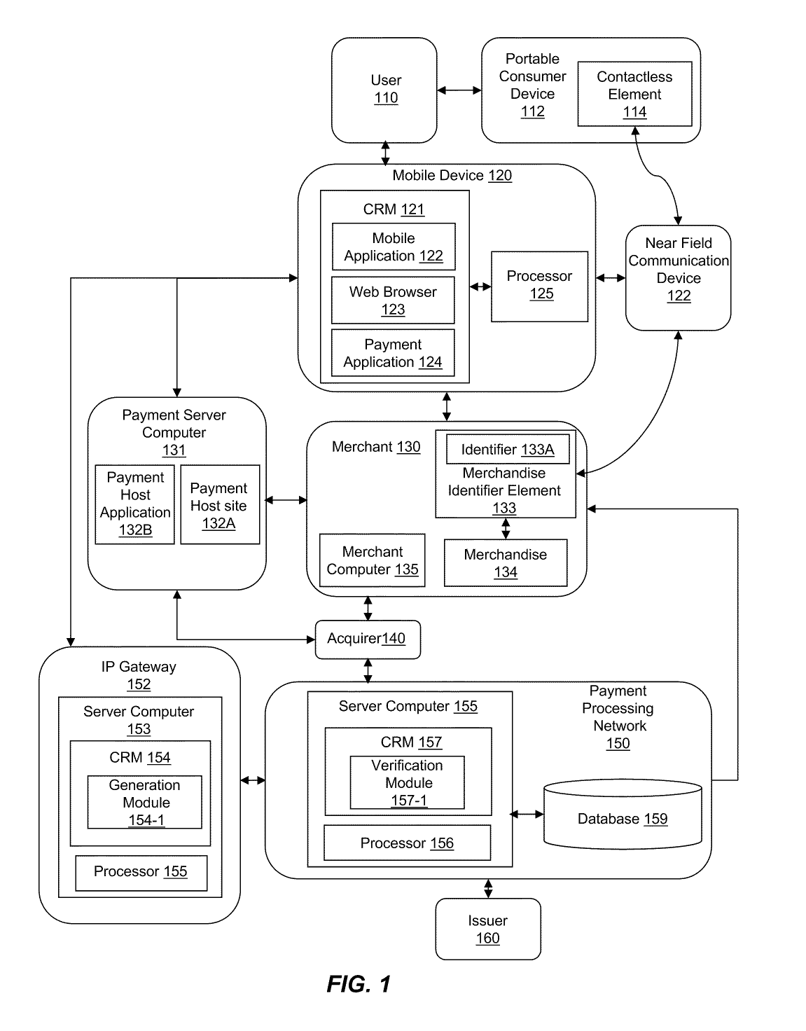

FIG. 1 shows a block diagram illustrating the components of a system according to one embodiment. FIG. 1 includes user 110 and a portable consumer device 112 that the user 110 may use to conduct a payment or other type of transaction. The user 110 may also use a mobile device 120 which is coupled to a near-field communications device 122 to interact with the merchant 130 and merchandise identifier element 133, which is coupled with the merchandise 134. In other embodiments, the near field communications device 122 may be present in the mobile device 120. The near-field communications device 122 can also communicates with the contactless element 114 of the portable consumer device 112. The user 110 may also use the mobile device 120 to communicate with the payment server computer 131. Payment server computer 131 includes the payment host site 132A and payment host application 132B. The mobile device 120 communicates with the payment host site 132A via the web browser 123, and communicates with the mobile host application 132B via the mobile application 122.

Payment host site 132A can be a web site that is accessible via a web browser (e.g. web browser 123) and the payment host application 132B is a server side application that communicates with the client side mobile applications (e.g. mobile application 122). Both the payment host site 132A and payment host application 132B also communicate with the merchant computer 135 and the acquirer 140. Merchant 130 communicates with the payment processing network 150 through the acquirer 140. Payment processing network 150 is in communication with the issuer 160.

Further elements of the system may include the IP Gateway 152 which may include an IP Gateway server computer 153, a processor 155 and a computer readable medium 154 that has a generation module 154-1 for generating dynamic verification values (dCVV2). The payment processing network 150 also may include a payment processing network server computer 155 which includes a processor 156 and a computer readable medium 157 that stores a verification module 157-1 for verification of incoming authorization request messages and dynamic verification values. The server computer 155 communicates with the database 159. The IP Gateway 152 is in communication with the mobile device 120, and payment processing network 150.

User 110 can interact with merchant 130 using the mobile device 120. This process will be described in detail later. Mobile device 120 is capable of communicating with the payment server computer 131 which is also accessible by the merchant 130 and/or acquirer 140. Mobile device 120 is also capable of communicating with the IP Gateway 152 for authentication of the portable consumer device 112.

In some embodiments, acquirer 140 may not be participating in the transaction processing as shown in FIG. 1. In such embodiments, the merchant 130 and the payment server computer 131 may directly communicate with the payment processing network 150 or the issuer 160.

User 110 refers to an individual or organization such as a business that is capable of purchasing goods or services or making any suitable payment transaction with merchant 130.

Portable consumer device 112 refers to any suitable device that allows the payment transaction to be conducted with merchant 130. Portable consumer device 112 may be in any suitable form. For example, suitable portable consumer devices 112 can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices 112 include cellular phones, personal digital assistants (PDAs), pagers, payment cards, security cards, access cards, smart media, transponders, and the like. In some cases, portable consumer device 112 may be associated with an account of user 110 such as a bank account.

Portable consumer device 112 may include a contactless element 114 that includes one or more processors (not shown), antenna (not shown), one or more computer readable mediums (not shown), and one or more applications stored on the computer readable mediums that operate in concert to allow the portable consumer device 112 to wirelessly send and receive data. The contactless element 114 provides Near-field communication capability for the portable consumer device 112 such that when the portable consumer device 112 is in close proximity of a wireless reader (such as the near-field communication device 122), the wireless reader powers the contactless element 114 and collects the card data.

Mobile device 120 may be in any suitable form. For example, suitable mobile device 120 can be hand-held and compact so that they can fit into a consumer's wallet and/or pocket (e.g., pocket-sized). Some examples of mobile device 120 include desktop or laptop computers, cellular phones, personal digital assistants (PDAs), pagers, payment cards, security cards, access cards, smart media, transponders, and the like. In some embodiments, mobile device 120 and portable consumer device 112 are embodied in the same device.

Mobile application 122 and payment application 124 may be software applications stored on a computer readable medium in a mobile device (e.g. mobile device 120) and run by a processor. The mobile application 122 and payment application 124 are capable of communicating with a server computer (e.g. payment server computer 131). Mobile application 122 may be used to communicate with the payment host application 132B to view the merchandise and/or services that the user 110 wishes to purchase. Payment application 124 may store the credit/debit card data associated with the portable consumer device 112 of the user 110 and submit such data to the payment server computer 131.

Web browser 123 may be a software application for retrieving, presenting, and traversing information on server computers. Web browser 123 may use any appropriate protocol such as the Hypertext Transfer Protocol (HTTP) to communicate with the payment server computer 131. Web browser 123 may be specifically designed to run on a mobile device (e.g. mobile device 120) or a general-purpose computer. Web browser 123 is used to communicate with the payment host site 132A to view the merchandise and/or services that the user 110 wishes to purchase.

Near-field communication device 122 can be an electronic device that is capable of sending data and receiving data wirelessly. Near-field communication device 122 may be coupled to the mobile device 120 (externally or internally) to allow the mobile device 120 send and receive data wirelessly from sources in close proximity of the mobile device 120. In some embodiments, a “hot key” on the mobile device 120 may be used to enable a “reader emulation mode” in the near-field communication device 122. In some other embodiments, the near-field communication device 122 coupled to the mobile device 120 may automatically receive data when in proximity of a contactless portable consumer device 112. Near-field communication device 122 includes one or more processors (not shown), antenna (not shown), one or more computer readable media (not shown), and one or more applications stored on the computer readable media that operate in concert to allow the near-field communication device 122 wirelessly send and receive data. When the near field Communication (NFC) device 122 is in close proximity of the identifier 133A and contactless element 114, it will power the processors (not shown) of these devices. Identifier 133A and contactless element 114 then wirelessly transmit data stored in their memory (not shown) via their antenna (not shown) to the near-field communication device 122.

Merchant 130 refers to any suitable entity or entities that make a payment transaction with user 110. Merchant 130 may use any suitable method to make the payment transaction. For example, merchant 130 may use an e-commerce business to allow the payment transaction to be conducted by merchant 130 and user 110 through the Internet. Other examples of merchant 130 include a department store, a gas station, a drug store, a grocery store, or other suitable business.

Payment host site 132A may be in the form of a website hosted by one or more server computers (e.g. payment server computer 131). User 110 is capable of communicating with the payment host site 132A using the mobile device 120 and/or any form of electronic device capable of communicating with a server computer via the Hypertext Transfer Protocol (HTTP) or any other suitable protocols such as HTTPS. In some embodiments, payment host site 132A may be a mobile website designed for mobile devices. In other embodiments, the payment host site 132A may be a regular website also accessible by mobile devices. Payment host site 132A may be hosted by a third party processor which communicates with the users, merchants, acquirers, and payment processing networks.

Payment host application 132B may be in the form of a server side application capable of communication with mobile applications (e.g. mobile application 122). User 110 is capable of communicating with the payment host application 132B using the mobile device 120. Payment host application 132B may be hosted by a third party processor which communicates with the users, merchants, acquirers, and payment processing networks.

Acquirer 140 refers to any suitable entity that has an account with merchant 130. In some embodiments, issuer 160 may also be acquirer 140.

Payment processing network (PPN) 150 refers to a network of suitable entities that have information related to an account associated with portable consumer device 112. This information includes data associated with the account on portable consumer device 112 such as profile information, data, and other suitable information.

Payment processing network 150 may have or operate a server computer and may include a database. The database may include any hardware, software, firmware, or combination of the preceding for storing and facilitating retrieval of information. Also, the database may use any of a variety of data structures, arrangements, and compilations to store and facilitate retrieval of information. The server computer may be coupled to the database and may include any hardware, software, other logic, or combination of the preceding for servicing the requests from one or more client computers. Server computer may comprises one or more computational apparatuses and may use any of a variety of computing structures, arrangements, and compilations for servicing the requests from one or more client computers.

Payment processing network 150 may include data processing subsystems, networks, and operations used to support and deliver authorization services, exception file services, and clearing and settlement services. An exemplary payment processing network 150 may include VisaNet™. Networks that include VisaNet™ are able to process credit card transactions, debit card transactions, and other types of commercial transactions. VisaNet™, in particular, includes a integrated payments system (Integrated Payments system) which processes authorization requests and a Base II system which performs clearing and settlement services. Payment processing network 150 may use any suitable wired or wireless network, including the Internet.

IP Gateway 152 refers to an entity that includes one or more servers and databases, and have access to various issuer data, transaction data and user data used to authenticate the portable consumer devices. IP Gateway 152 also generates and delivers notifications and alert messages to various delivery channels. IP Gateway 152 may be part of the payment processing network 150 or may be a separate entity in communication with payment processing network 150.

Issuer 160 refers to any suitable entity that may open and maintain an account associated with portable consumer device 112 for user 110. Some examples of issuers may be a bank, a business entity such as a retail store, or a governmental entity. In many cases, issuer 160 may also issue portable consumer device 112 associated with the account to user 110.

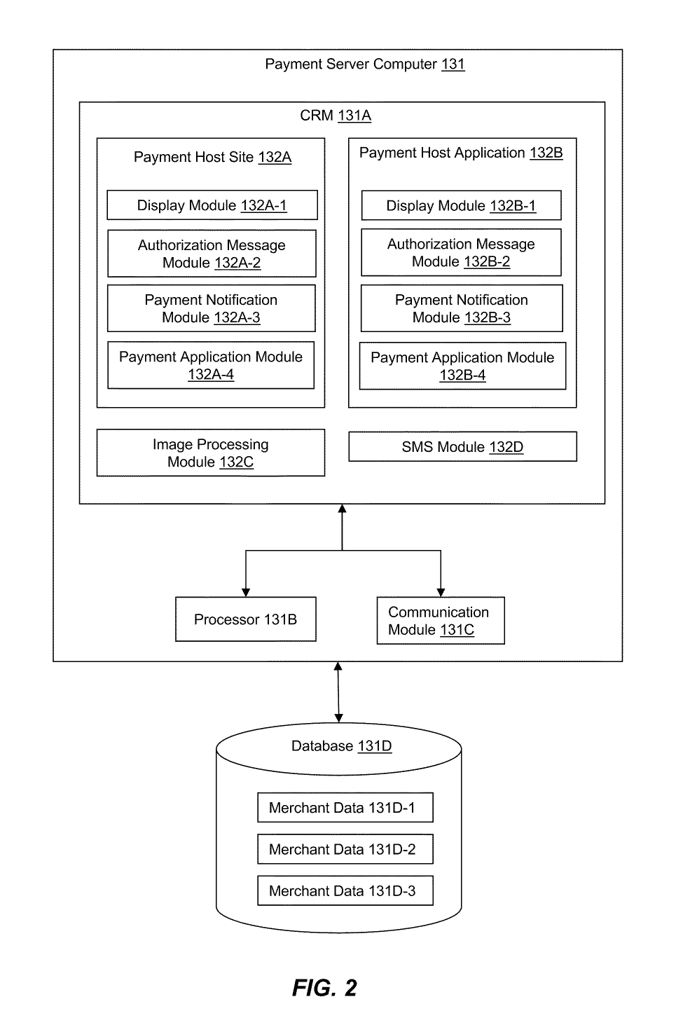

The databases 159 and 131D (shown in FIG. 2) may be server computers that are capable of storing data and responding to queries from client computers. The databases 159 and 131D may also be in the form of stand-alone hard drives connected to one or more server computers that retrieve the data from the databases 159 and 131D as result of queries from client computers.

FIG. 2 illustrates some components of the payment server computer 131 that is shown in FIG. 1 as well as the database 131D (not shown in FIG. 1) that communicates with the payment server computer 131. The payment server computer 131 includes a computer readable medium 131A coupled to a processor 131B, and a communication module 131C coupled to the processor 131B.

Communication module 131C may be a device such as a modem that connects the payment server computer 131 to a communication network (e.g. the Internet) and the facilitates the incoming and outgoing communications to and from the payment server computer 131 with other servers, computers, mobile devices, etc.

The computer readable medium 131A stores the payment host site 132A, the payment host application 132B, an image processing module 132C, and a SMS module 132D. Each of the payment host site 132A and payment host application 132B include modules that facilitate and perform various operations in the embodiments of the invention. Each of these modules and their functions will now be described.

Display modules 132A-1 and 132B-1 communicate with the database 131D and display a particular merchandise or service and its associated information such as price, description, reviews, warranty information, etc. that may be available. Such data are stored in the merchant data 131D-1, 131D-2, 131D-3 each of which is associated with a particular merchant. Display module 132A-1 is configured to display the merchandise and/or service information provided by a merchant in a web browser (e.g. web browser 123) and display module 132B-1 is configured to display the merchandise and/or service information provided by a merchant in a mobile application (e.g. mobile application 122).

Authorization message modules 132A-2 and 132B-2 generate authorization request messages from the data received from the mobile device 120 of the user 110. Such data may include, among other types of data, data and information included in the identifier 133A (which may include price, merchant ID, and merchandise ID or service ID), account information (e.g. credit/debit card number, expiration date, etc.) associated with the portable consumer device 112.

Payment notification modules 132A-3 and 132B-3 generate notification messages after completion of the payment transaction. Notifications are sent from the payment server computer 131 to the merchant computer 135 or any other suitable electronic device such as Point of Sale (POS) device used by merchant 130 to receive such notification. Notifications may include any appropriate types of data and information such as a reference/verification number, amount of the payment, date and time of the payment, etc. that allows the merchant to associate a payment with a merchandise and/or service, and a user who has made the payment.

Payment notification modules 132A-3 and 132B-3 may also generate a notification that is sent to the mobile device 120. Such notification may be in the form of a receipt, reference number, confirmation number, etc. that may include any appropriate type of data and information such as the amount of the payment, date and time of the payment, and recipient of the payment that allows the user 110 to provide such information as a proof of payment for goods and services.

Payment application modules 132A-4 and 132B-4 communicate with the databases (e.g. database 131D, database 159 in the payment processing network 150, or other databases operated by the issuer 160 or IP Gateway 152) that contain user enrollment data. User 110 may enroll the account information associated with the portable consumer device 112 and then use the payment application 124 to submit a payment. Payment application modules 132A-4 and 132B-4 facilitate the communication between the payment application 124 with the enrolled user data, and associate a payment made through the payment application 124 with a particular merchant and a particular merchandise and/or service.

Image processing module 132C is used in the embodiments where the identifier 133A is sent from the mobile device 120 in the form of a digital image. As will be described in detail, user 110 may take a picture of the merchandise identifier element 133 which may be attached to the merchandise or shown on a television display. Image processing module 132C analyzes the image and generates the information included in the identifier 133A from the digital data associated with the image.

SMS module 132D is used in the embodiments where the user 110 initiates a connection with the payment server computer 131 via text message. In such embodiments which will be described later, the user 110 sends a text message containing the information associated with the identifier 133A. The SMS module 132D then accesses the user account information provided during an enrollment process and then performs the payment transaction by communicating with other appropriate modules.

II. Methods

In the embodiments of the invention, the merchant 130 works with the payment server computer 131 which may be operated by a third party processor to enable the user 110 to purchase goods and services from the merchant 130 without submitting his or her payment card information directly to the merchant 130. In order for merchant 130 to provide this capability to the user 110, the merchant 130 works with the third party processor to establish an account and to provide its merchandise and/or service information to the payment server computer 131. The payment server computer 131 can operate a payment host site 132A that is accessible via web browser and/or a payment host application 132B accessible via a mobile application on a mobile device. User 110 can communicate with the payment host site 132A and/or payment host application 132B via his mobile device 120 and submit his or her credit/debit card number to the payment host site 132A and/or payment host application 132B instead of the merchant 130. Once a payment is made, the merchant 130 is notified and the user 110 receives the goods or services from the merchant 130.

The third party processor may be the acquirer 140, the payment processing network 150, the issuer 160 or any other third party that receives the payment from the user 110 on behalf of the merchant 130 via the payment host site 132A and/or payment host application 132B hosted on the payment server computer 131.

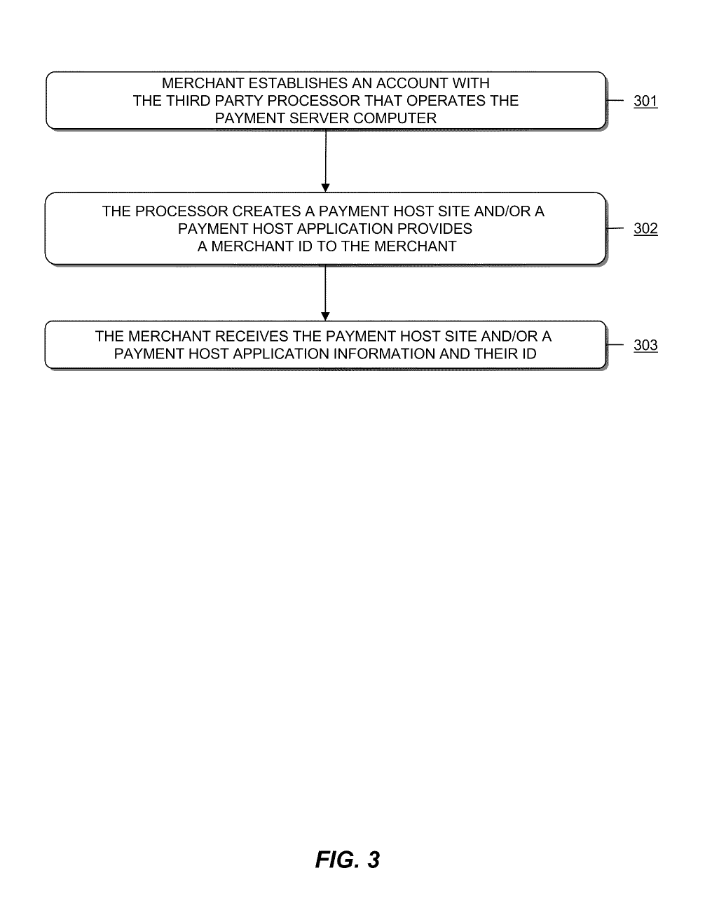

FIG. 3 illustrates the process in which merchant 130 establishes the payment host site 132A and/or payment host application 132B. In step 301 the merchant establishes the account with a third party processor that operates the payment server computer 131. In step 302, the third party processor creates a payment host site 132A and/or payment host application 132B for the merchant 130 and provides a merchant ID to the merchant 130 (step 303).

The merchant 130 may then access the payment host site 132A and/or payment host application 132B and can create a catalog of the merchandise sold and/or services provided by the merchant 130. The merchant 130 may include any suitable types of information about the merchandise or services including pictures, video, price, merchandise/service description, warranty information, reviews, etc.

The merchant 130 may also tag the merchandise with a merchandise identifier element 133. The merchant 130 or the third party processor may associate each type of merchandise with one or more identifiers such as a merchant ID and the merchandise ID. Such identifiers may then be included as the identifier 133A in the merchandise identifier element 133. As will be described in detail later, the merchandise identifier element 133 may be capable of near-field communication or may be a sticker that shows the information (e.g. merchant ID and the merchandise ID, URL address of the payment host site 132A, etc.) needed by the user 110 to communicate with the payment server computer 131 and make a payment. This step may be optional since the merchant 130 may only sell one type of merchandise, or the merchant 130 may provide the information needed for user 110 to make a payment without specifying a particular piece merchandise (this process will be described in detail later).

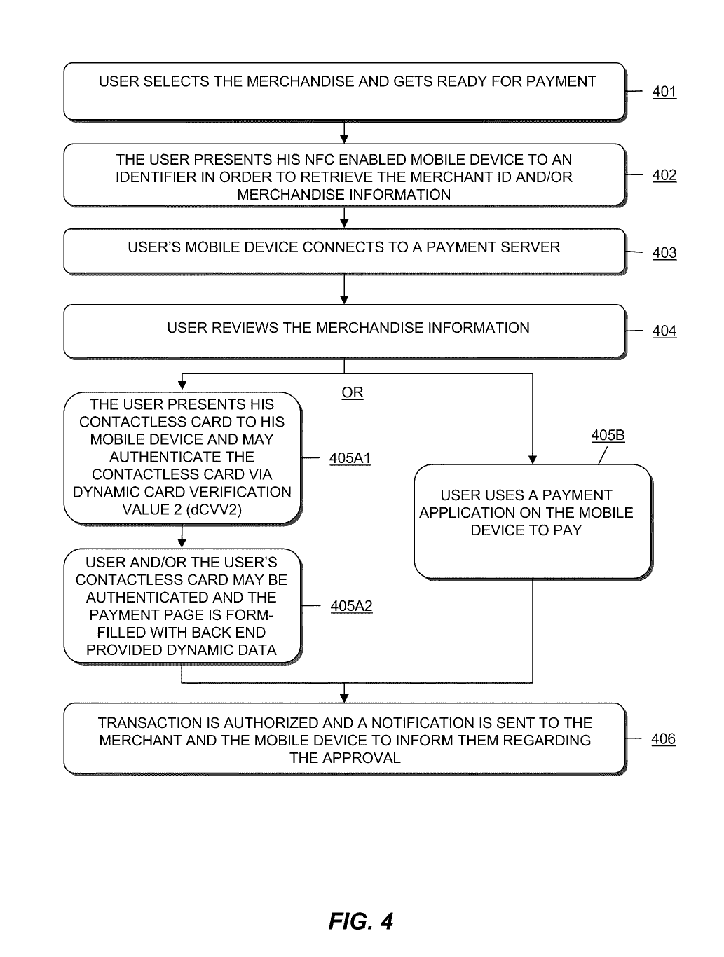

The process of payment transaction, according to one embodiment of the invention, can now be described with reference to the flowchart shown in FIG. 4 and FIGS. 5-9 which show each step from the view of the user 110. In a typical transaction process, the user selects a merchandise at a merchant location and gets ready for making payment (step 401). The user 110 may use his mobile device 120 to interact with the merchandise 134 in which he is interested in purchasing. In some embodiments, the merchandise 134 may have a merchandise identifier element 133 which is capable of wirelessly communicating with near-field enabled communication devices such as near-field communication device 122. The merchandise identifier element may be an RFID tag or any suitable device that can store data and when in close proximity of a near-field reader (e.g. Near-field communication device 122) transmit its data.

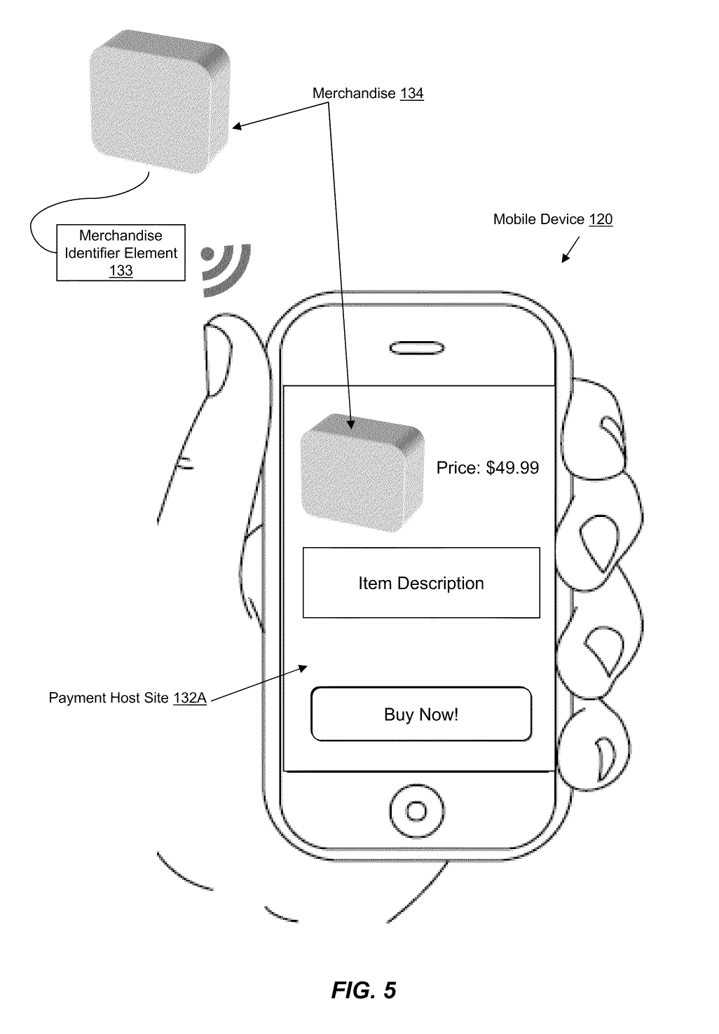

Mobile device 120 of the user 110 may be coupled to a near-field communication device 122 as shown in FIG. 1, or the near-field communication device may be embedded in the mobile device 120. In step 402, the user 110 presents his near-field enabled mobile device 120 to the merchandise identifier element 133. The mobile device 120 then receives the identifier 133A (which is the form of computer-readable data) from the merchandise identifier element 133. Next, in step 403, the user's mobile device 120 connects to the payment server computer 131. FIG. 5 illustrates an exemplary mobile device 120 being used in the process of purchasing merchandise 134.

In some embodiments, upon receiving the identifier 133A from the merchandise identifier element 133, the mobile device 120 may automatically initiate a connection to the payment sever computer 131 which hosts the payment host site 132A and/or payment host application 132B. Mobile device 120 may communicate with the payment server computer 131 via the mobile application 122 or the web browser 123. In some embodiments, user 110 may initiate a connection with the payment server computer 131 prior to presenting his near-field enabled mobile device 120 to the merchandise identifier element 133.

For example, user 110 may type a URL (Uniform Resource Locator) (e.g. http://www.Visa_direct_payment.com/merchant123) into the web browser 123 and connect to the payment host site 132A. Thereafter, the user 110 may present his near-field enabled mobile device 120 to the merchandise identifier element 133. The mobile device 120 may then retrieve the identifier 133A stored in the merchandise identifier element 133 and send the identifier 133A using the web browser 123 to the payment host site 132A.

In some embodiments, the mobile device 120 may include a security module (not shown) that allows the user 110 to use the near-field capability of the mobile device 120 or initiate a payment transaction via the mobile application 122, web browser 123 and payment application 124 upon providing a password or a PIN by the user 110.

As shown in FIG. 5, when the merchandise information are received by the payment host site 132A, the merchandise is identified and displayed on the payment host site 132A which is accessed by user 110 via the web browser 123. As shown in FIG. 5, user 110 may be able to see the merchandise 134, the price of the merchandise and description of the merchandise including warranty information and reviews (step 404 in FIG. 5).

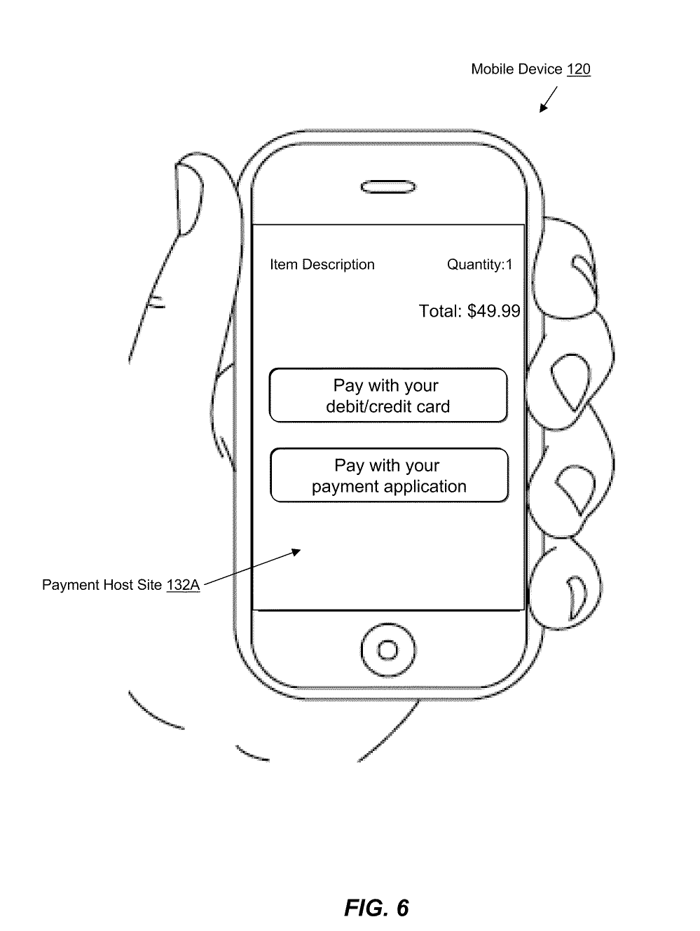

In the exemplary purchase process shown in FIG. 5, when user 110 is ready to make payment, he or she can press “Buy Now” to start the payment process. As shown in FIG. 6, user 110 may then be presented with multiple payment options. The flowchart of FIG. 4, illustrates the two payment options that are presented to the user 110 which are shown in FIG. 6. As a first option, the user 110 may choose to use his portable consumer device 112 to pay for the merchandise 134.

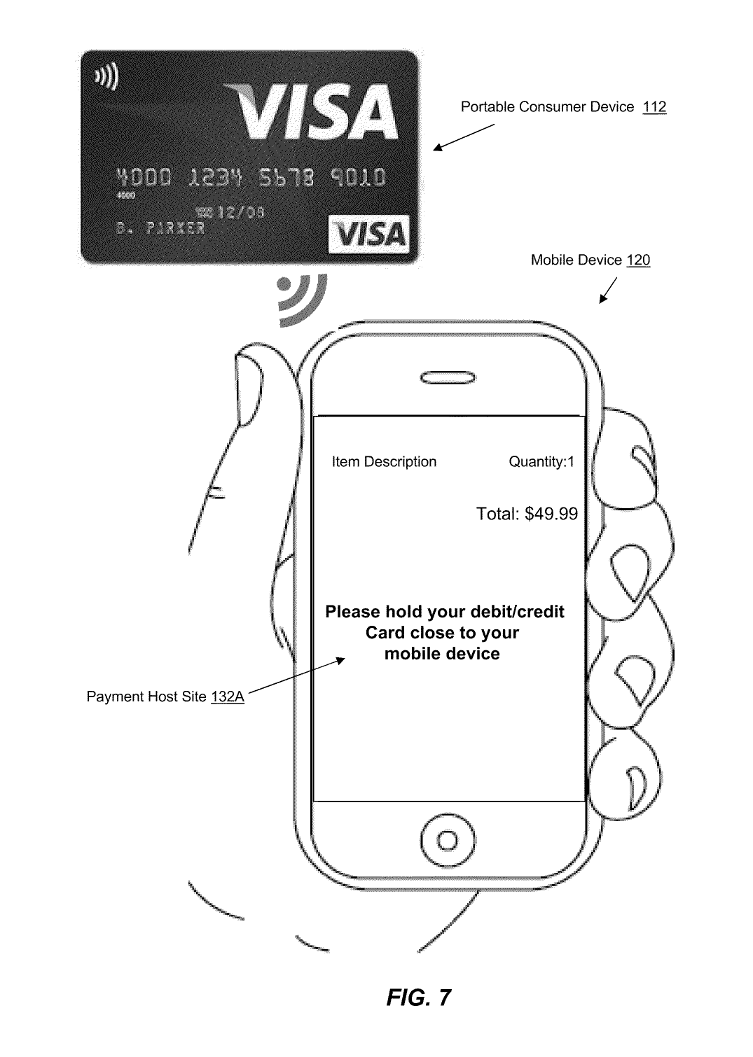

When the user 110 chooses the option to pay via his portable consumer device 112, in some embodiments, and in the interest of more security, a dynamic verification value may be used to authenticate the user 110 and/or the portable consumer device 112. In such embodiments, as shown in FIG. 7, user 110 presents his portable consumer device 112 to mobile device 120. The near-field communication device 122 communicates with the contactless element 114 of the portable consumer device 112 and receives the card data associated with the portable consumer device 112. Such card data may be the Primary Account Number (PAN) associated with the portable consumer device 112, name of the user 110, expiration date, etc. When such card data are received from the portable consumer device 112, mobile device 120 may communicate with the IP Gateway 152 to request for a dynamic verification value (step 405A1 in FIG. 4). Mobile device 120 may communicate with the IP Gateway server computer 153 via an application on the computer readable medium 121 which is run by the processor 125. In some embodiments, the connection between the mobile device 120 and the IP Gateway 152 may be a secure SSL (Secure Sockets Layer) connection.

Further detail about the process involved in requesting, generating, and using a dynamic verification value in payment transactions may be found in U.S. patent application Ser. No. 12/712,148, filed on Feb. 24, 2010, and U.S. patent application Ser. No. 12/939,963 filed on Nov. 4, 2010, which are herein incorporated by reference in their entirety for all purposes.

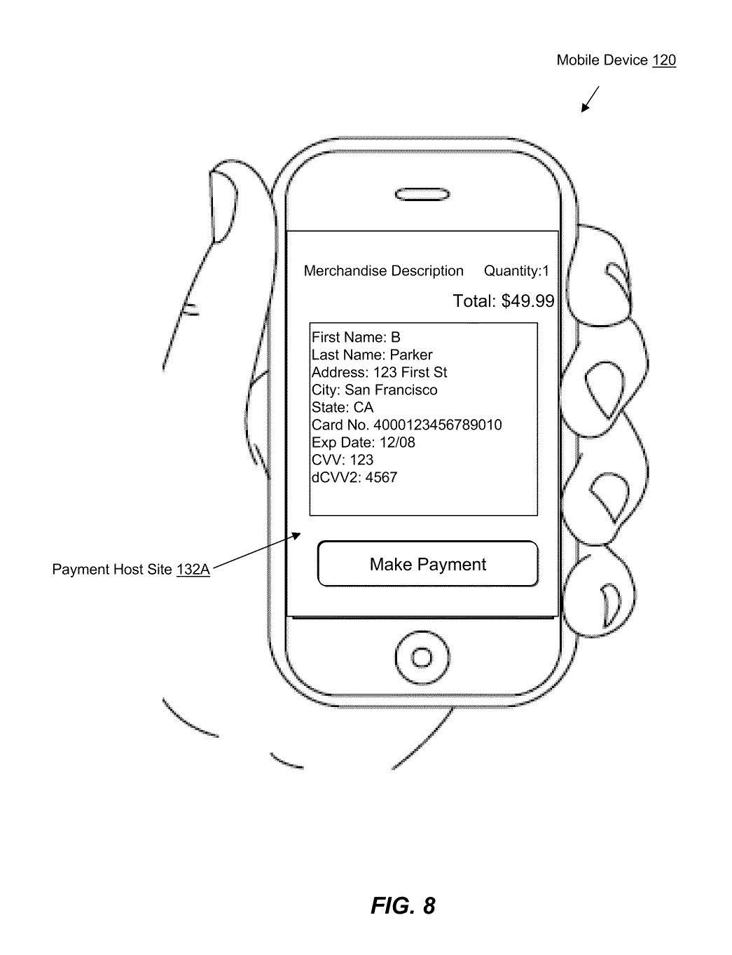

Upon receiving a request for a dynamic verification value and after a verification process, the generation module 154-1 of the IP Gateway 152 generates a dynamic verification value which is sent to the mobile device 120. At step 405A2 shown in FIG. 4, the payment page of the payment host site 132A is form-filled with the information needed by the payment host site 132A to generate an authorization request message. An example is shown in FIG. 8 in which the name, address, account number, expiration date, card verification value (CW) of the credit/debit card, and the dynamic verification value (dCVV2) are form-filled into a payment page of the payment host site 132A. In some embodiments, user 110 may manually type such information into the payment page shown in FIG. 8 and may not use a dynamic verification value, or may receive the dynamic verification value by using other means (e.g. text message) and manually enter the dynamic verification value into the payment page.

At this point, user 110 submits the payment and the payment host site 132A generates an authorization request message. In some embodiments, the authorization request message is send to the acquirer 140 which then forwards it to the payment processing network 150. Payment processing network 150 validates the authorization request message using the validation module 157-1 and forwards it to the issuer 160. In some embodiments, the validation module 157-1 receives a copy of the dynamic verification value from the IP Gateway 152 and compares it with the one included in the authorization request message. If they match, the validation module 157-1 validates the authorization request message.

When the issuer 160 receives the authorization request message, it will generate an authorization response message which indicates whether the transaction had been approved or not. The authorization response message is sent to the payment processing network 150 which forwards it to the acquirer 140. Acquirer 140 then notifies the merchant 130 and the payment server computer 131.

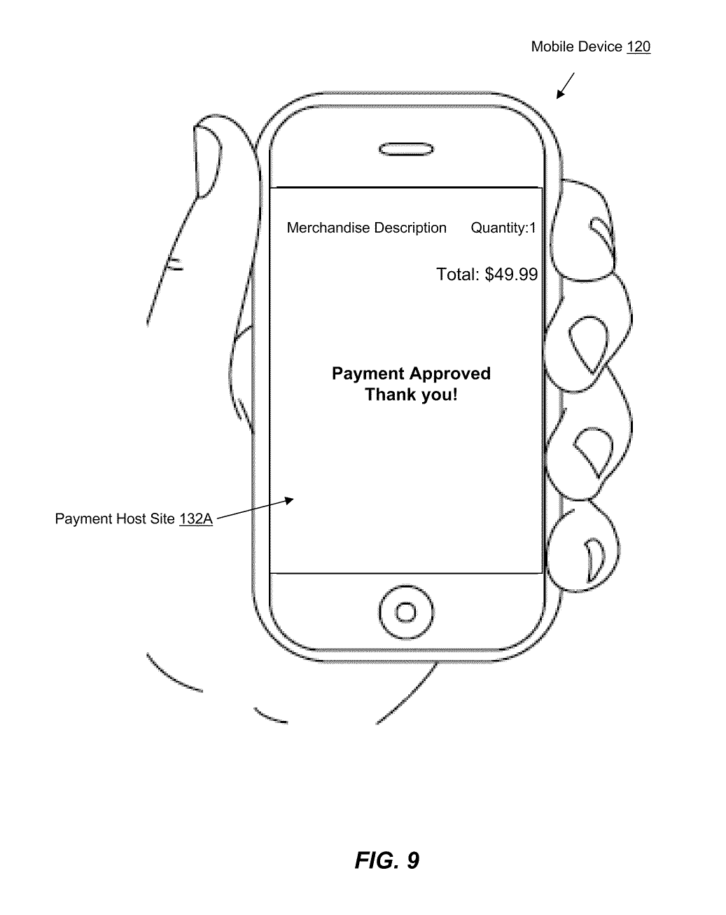

Once the payment transaction is approved (i.e. authorization response message is received) the user 110 will be notified as shown in FIG. 9. Also, as mentioned above the merchant 130 will be notified (step 406 in FIG. 4). The merchant 130 may receive a notification via the merchant computer 135, a Point of Sale (POS) device (not shown) or any device than can be used to receive an electronic notification from the payment server computer 131. The merchant computer 135 has a processor (not shown) and a computer readable medium (not shown) that stores one or more software application that allows the merchant computer 135 to communicate with the payment server computer 131 and receive the notification.

Optionally, in addition or instead of the notification that that merchant 130 receives from the payment server computer 131, the acquirer 140 or the issuer 160 may send a notification. The notification from the payment server computer 131 may include detail about the merchandise that user 110 purchased. For example, payment server computer 131 may communicate with the merchant computer 135 and confirm that the merchandise 134 was purchased by user 110 and a payment was received. The notification may include the information such as Stock Keeping Unit (SKU) and/or any type of information that is provided by the merchandise identifier element 133. In addition, the notification may include information that allows the merchant 130 determine that the payment was received from the user 110. Such information may include date and time of payment, and a reference number sent to both the merchant 130 and the mobile device 120 of the user.

In the above exemplary transaction, various modules of the payment host site 132A shown in FIG. 2 may operate in concert to perform the above operation. For example, display module 132A-1 may display the picture of the merchandise 134, its price and item description shown in FIG. 5. Authorization message module 132A-2 may generate the authorization request message when the user 110 submits a payment as shown in FIG. 8. Furthermore, the payment notification module 132A-3 may generate a notification shown in FIG. 9, and in addition, notify the merchant 130.

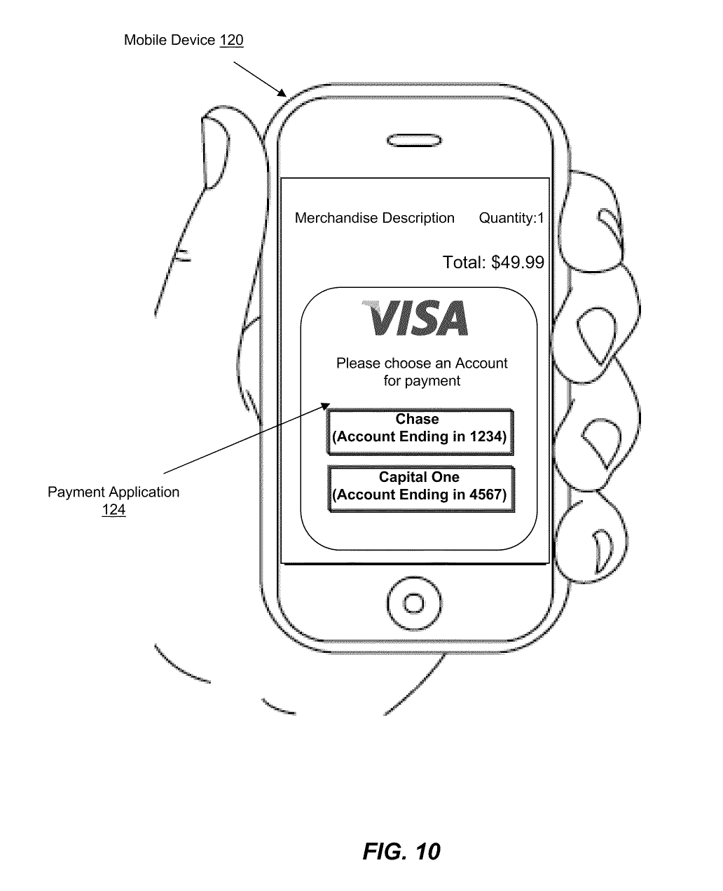

Referring back to the flowchart of FIG. 4, instead of payment via a portable consumer device 112, user 110 may choose to make a payment via a payment application (e.g. payment application 124) on his mobile device 120 (step 405B). FIG. 6 shows that user 110 can choose a payment application on mobile device 120. When the user 110 selected the “pay with your payment application” option shown in FIG. 6, the payment application 124 will be loaded. FIG. 10 shows an exemplary payment application that includes two credit/debit accounts of user 110 from which user 110 can choose one of the accounts for payment. The exemplary accounts shown in FIG. 10 may be previously enrolled and registered with the payment server computer 131, issuer 160 or any entity that provides the payment application 124.

In the example of FIG. 10, the payment host site 132A opens the payment application 124. At this point, the payment application 124 may submit the account information associated with the user 110 to the payment host site 132A, and an authorization request message can be generated by the payment host site 132A. Alternatively, in some embodiments, the payment application 124 may generate an authorization request message. In such embodiments, the payment host site 132A sends the payment information such as price of the merchandise, merchant ID, etc. to the payment application 124. Payment application 124 can generate an authorization request message and forward it to the acquirer 140, issuer 160 or the payment processing network 150.

As described before, when the payment server computer 131 receives an authorization response message, it sends a notification to the merchant 130 and the user 110.

In the above example, the payment host application 132B may have been used instead of the payment host site 132A. In this case, the user 110 would use the mobile application 122 to communicate with the payment server computer 131 and perform the above steps to make a payment.

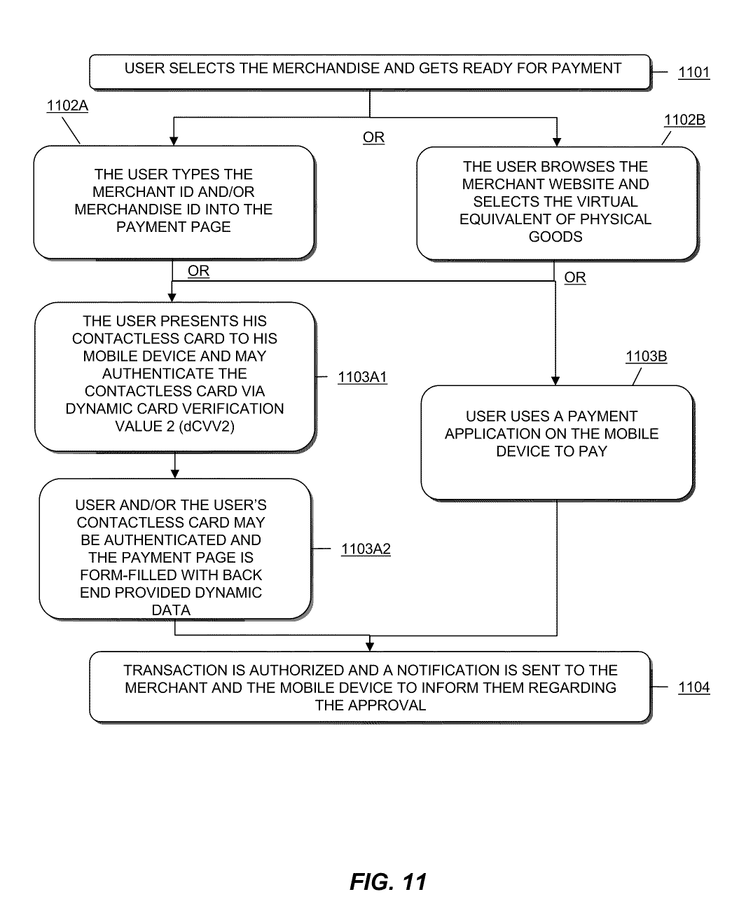

FIG. 11 illustrates a flowchart that shows other alternative methods of performing a payment transaction according to the embodiments of the inventions. The steps shown in FIG. 11 are similar to steps shown in FIG. 4 except for steps 1102A and 1102B.

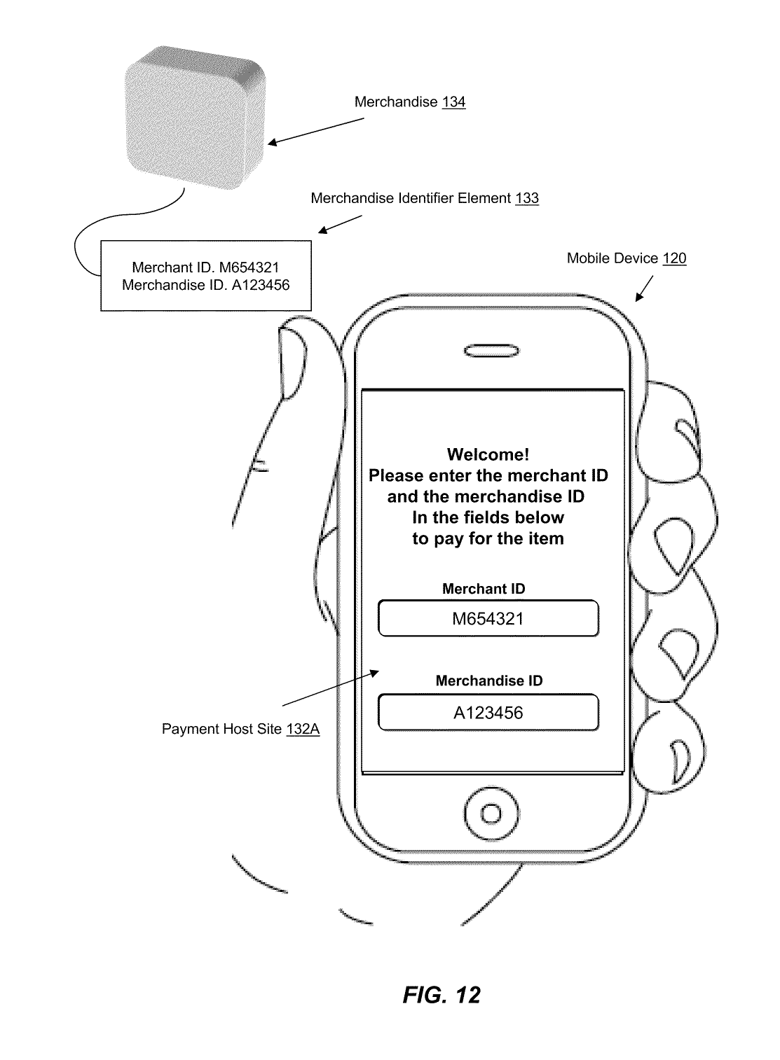

In step 1102A, user 110 types the merchant ID and the merchandise ID into a payment page of the payment host site 132A. An example is shown in FIG. 12 where the user 110 can enter the merchant and merchandise ID to locate and purchase the merchandise 134. The merchandise identifier element 133 shown in FIG. 12 may not be capable of near-field communication and instead may be in the form of a human-readable sticker showing the merchant ID and a merchandise ID. User 110 may then see the merchandise 134 and its price and description (similar to FIG. 5). Thereafter, similar to the steps shown in FIG. 4, user 110 pay for the merchandise.

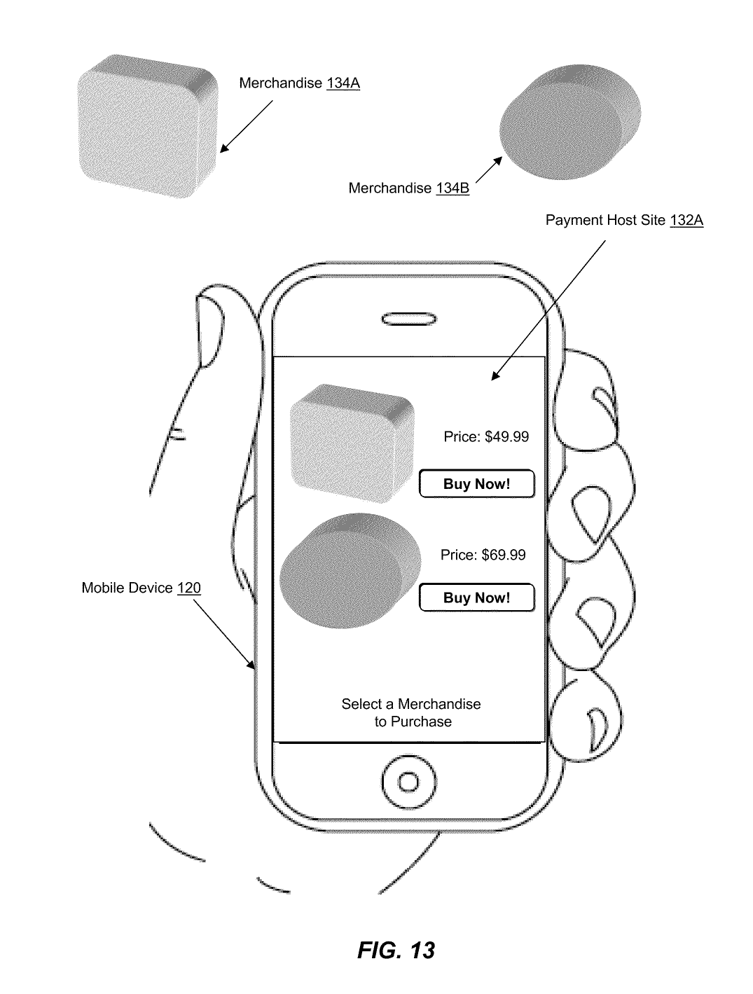

Referring back to the flowchart of FIG. 11, alternatively, in step 1102B, user 110 can use the web browser 123 to communicate with payment host site 132A and browse through the virtual equivalents of the merchandise being sold by the merchant 130. FIG. 13 shows an exemplary embodiment, where user 110 can view a catalog of the merchandise sold by the merchant 130. User 110 may then select the virtual equivalent of the merchandise and pay for the item by following the steps of FIG. 4.

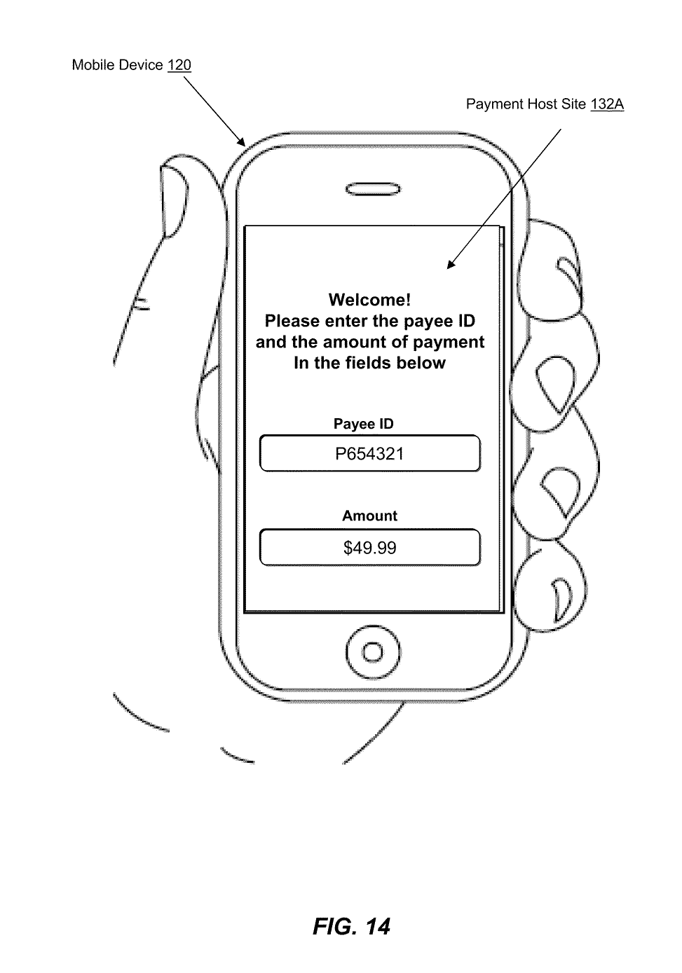

In some embodiments, the merchant 130 may be a type of merchant that sells a limited types of merchandise or services. For example, the merchant 130 may be a merchant that only sells hot dog and beer at a concert or a sport stadium. In such cases, due to the limited types of merchandise, the merchant may not use a merchandise identifier element. FIG. 14 shows an exemplary embodiment, where user 110 can pay the merchant 130 by typing a payee identifier or payee ID and the amount of the payment in the payment host site 132A. The payee identifier may be unique to the merchant, and the payment host site 132A can identify the recipient of the payment from the payee identifier. In some embodiments, the payee identifier may be associated with a sales person or a sales station in the merchant's location. Therefore, when two users make a payment at the same time, payment host site 132A can distinguish the sales persons or the sales stations using the payee identifier.

In one example, user 110 may go a store and purchase a merchandise from a sales person. The sales person then provides the user 110 with a payee identifier (e.g. P654321 as shown in FIG. 14), a URL for the payment host site 132A and the total amount of the merchandise(s) or service(s) that the user whishes to purchase. User 110 may then use the mobile device 120 and communicate with the payment host site 132A via the web browser 123. Thereafter, as shown in FIG. 14, user 110 types the payee identifier and the amount of payment in the payment page of the payment host site 132A. Similar to the steps of the flowchart show in FIG. 4, user 110 can use his portable consumer device 112 or the payment application 124 to make the payment.

When the user 110 submits the payment and the payment transaction is complete, the payment host site 132A sends a notification to the merchant 130 or the POS terminal at the merchant location. In some embodiments, the payment host site 132A may provide a reference number to both the user 110 via his mobile device 120 and to the merchant 130 via the merchant computer 135 so that the merchant 130 can associate a payment with the user 110.

In the embodiments of the invention, other alternative methods may be used by the user 110 to receive the merchandise or service information needed to communicate with the payment server computer 131 and pay for goods and services. In some embodiments, the user 110 may user his mobile device 120 to take a picture of the merchandise identifier element 133 (shown in FIG. 12) associated with merchandise (e.g. merchandise 134). A mobile application (e.g. mobile application 122) may send the picture to the payment server computer 131 where the image processing module 132C analyzes the picture and provides the information of the merchandise to the payment host site 132A. Similar to the process described with reference to the flowchart shown in FIG. 4, the payment host site 132A may then show the merchandise, its price and any associated information for user 110 for review. User 110 may then follow the similar steps shown in FIG. 4 to submit a payment using his mobile device 120.

Similarly, when the user 110 wishes to pay for a service, the user 110 may take a picture of an identifier associated with that particular service. For example, a service provider may provide a menu containing various types of services provided. The menu may be in the form of a paper that lists the services along with their price and a code, image, barcode or any appropriate identifying means that can be captured by an image. Thereafter, the user 110 can take a picture of a particular item in the menu and pay for it via the process described above.

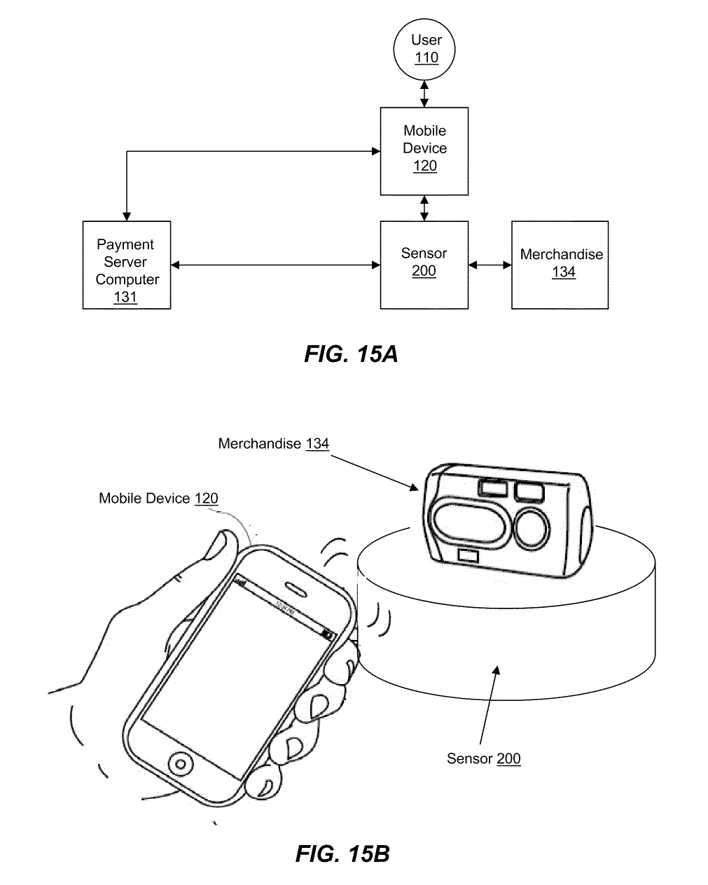

In some embodiments, the user 110 may use his mobile device 110 to interact with the merchandise and perform a payment transaction by tapping or “bumping” the mobile device 120 to the merchandise 134 or the merchandise identifier element 133. FIG. 15A shows an exemplary system where the merchandise identifier element is embodied as a sensor 200 which communicates with the payment server computer 131. FIG. 15B illustrates an exemplary embodiment, where the user 110 “bumps” his mobile device 120 to the sensor 200. In such embodiments, the mobile device 120 and the sensor 200 may have accelerometers or alternatively, pressure sensors. As a result of the movement of the mobile device 120 toward the sensor 200, the accelerometer or pressure sensor data may then be sent to the payment server computer 131. Thereafter, the information related to the merchandise 134 are displayed on the mobile device 120 through the web browser 123 or the mobile application 122. User 110 can then make a payment for the merchandise 134 via the process described above with reference to the flowchart of FIG. 4.

The payment server computer 131 can determine when the mobile device 120 moves towards the sensor 200 in any suitable manner. In one embodiment, the payment server computer 131 uses accelerometer data, time and location data from the mobile device 120 and the sensor 200 to associate the mobile device 120 with a particular piece of merchandise. Further detail about this process can be found in the U.S. patent application Ser. No. 12/952,811 filed on Nov. 23, 2010; U.S. patent application Ser. No. 12/953,368 filed on Nov. 23, 2010; and U.S. patent application Ser. No. 12/953,371 filed on Nov. 23, 2010, the entire disclosures of which are incorporated herein by reference in their entirety for all purposes.

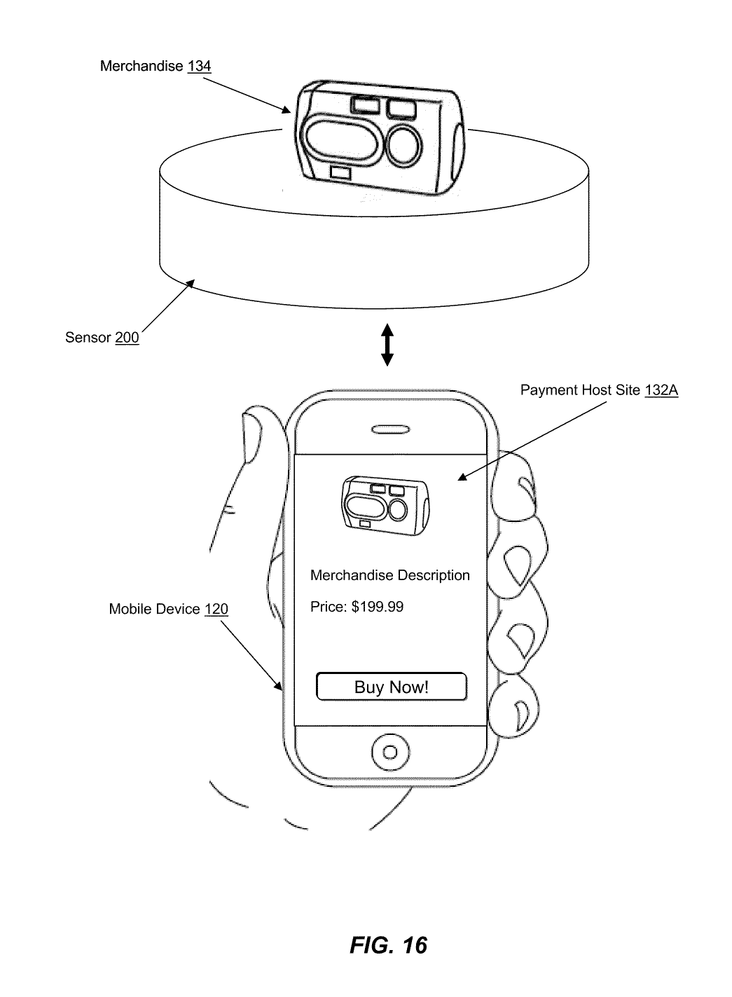

In some embodiments, the merchandise identifier element 133 may be embodied as the sensor 200 shown in FIG. 16 where it senses the removal of the merchandise. Sensor 200 may communicate wirelessly via a near-field communication protocol (e.g. via RFID or bluetooth) with the mobile device 120 and transmit the identifier data related to the merchandise 134 to the mobile device 120. In one example, the user 110 approaches the merchandise 134 shown in FIG. 16. The sensor 200 detects the presence of the mobile device 120 and sends the related information (identifier data) such as merchant ID and/or merchandise ID to the mobile device 120. The mobile device 120 then communicates with the payment server computer 131 as described before, and information associated with the merchandise such as description, price, warranty information, reviews, etc. may be displayed via the mobile application 122 or the web browser 123. User 110 may then purchase the merchandise 134 via the process described above.

In one embodiment, if the user 110 were to remove the merchandise 134 before successfully making a payment, an alarm would sound indicating unauthorized removal of a merchandise. Upon successful payment by the user 110, payment server computer 131 may disarm the sensor 200 so that user 110 can remove the merchandise 134. Sensor 200 may communicate with the payment server computer 131 via any suitable communication protocol or via a suitable intermediary device (e.g. merchant computer 135).

In some embodiments, when the sensor 200 is used in a store along with many other merchandise, the location information (e.g. GPS location) of the mobile device 120 along with the location information related to the sensor 200 may be sent to the payment server computer 131. Using the location information, the payment server computer 131 may determine which mobile device in the store is interacting with which sensor.

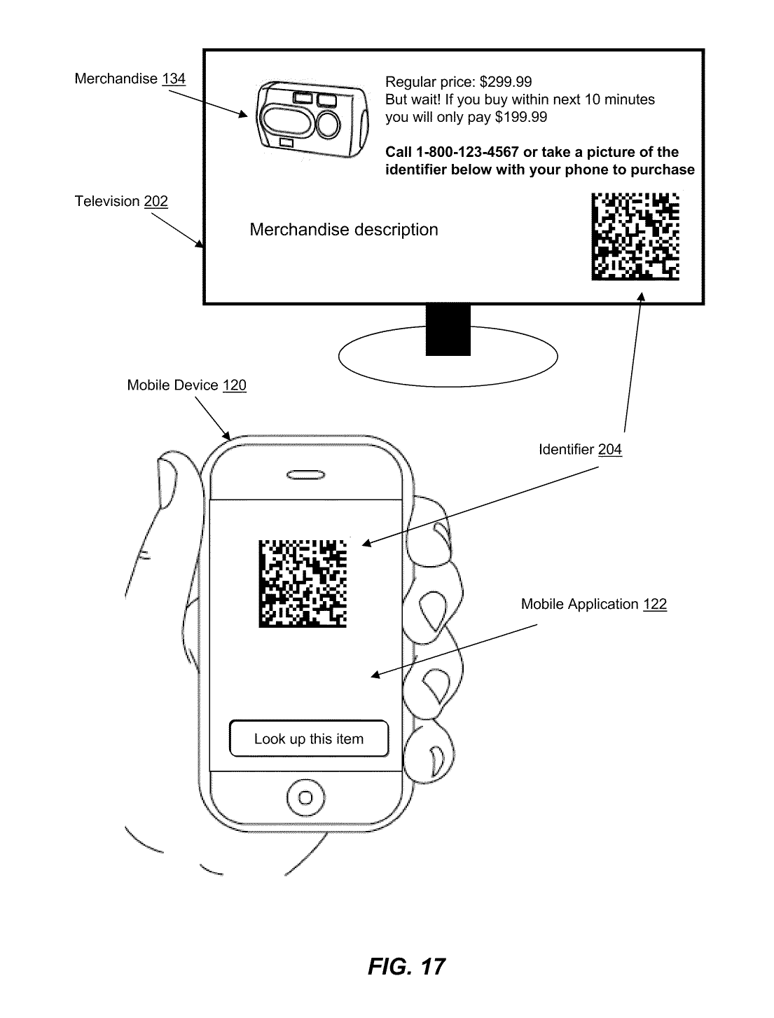

In the embodiments of the invention, the payment server computer 131 may be used for remote transactions. FIG. 17 shows an exemplary remote transaction where the user 110 buys a piece of merchandise that is being offered in a television commercial. In the exemplary embodiments shown in FIG. 17, the television commercial shown in television 202 shows a merchandise 134 which is a digital camera. An identifier 204 which is in the form of a two-dimensional bar code is displayed on the television 202. User 110 can take a picture of the identifier 204 via a mobile application (e.g. mobile application 122) on his mobile device 120. The mobile application 122 then communicates with the payment server computer 131. The image processing module 132C may then analyze the image and forward the data associated with the identifier 204 to the payment host site 132A or the payment host application 132B. The user 110 then receives the product information via the web browser 123 or the mobile application 122. Thereafter, similar to the process described with respect to the flowchart of FIG. 4, the user 110 can make a payment for the merchandise 134.

Merchant 130 will then be notified via the payment server computer 131 that merchandise 134 was purchased and will be provided with the shipping information of the user 110 to ship the merchandise.

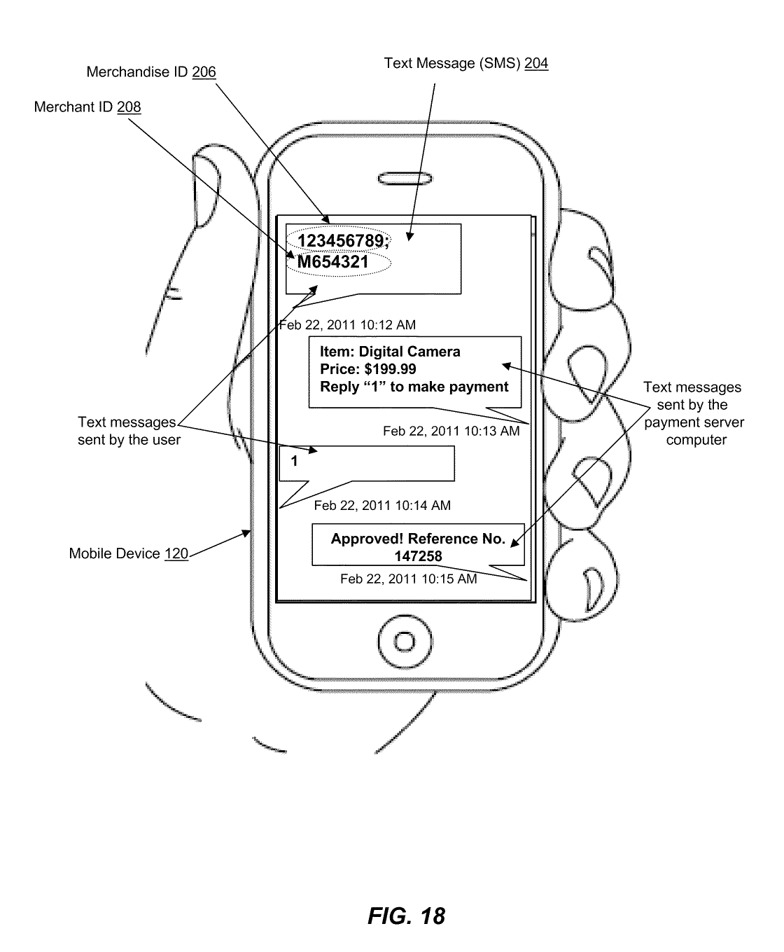

In some embodiments, the user 110 may use his mobile device to purchase goods or services in face-to-face or remote transactions by communicating with the payment server computer 131 via text message (SMS). FIG. 18 shows an exemplary embodiment that shows the process of making a payment via text message.

User 110 may use his mobile device 110 to communicate with the payment server computer 131 by “texting” an identifier associated with a good or service being sold by a merchant, to a known connection number associated with the payment server computer 131. The identifier may be in any suitable form. For example, the identifier may be in the form of one or more string of numeric and/or alpha-numeric values. The connection number may be a short code (e.g. 222-123) or an ordinary phone number (e.g. 415-123-4567) associated with the payment server computer 131. In this embodiment, user 110 may have previously enrolled the account associated with his portable consumer device 112 with the payment server computer 131.

As shown in the example of FIG. 18, user 110 can “text” the identifier which is shown in the form of a numerical string (merchandise ID 206) and an alpha-numeric string (merchant ID 208) to a number associated with the payment server computer 131. In the example of FIG. 18, the identifiers are associated with the merchandise 134 shown in FIG. 17. In this example, user 110 makes a payment for the digital camera (merchandise 134) shown in FIG. 17 by communicating with the payment server computer 131 via text message (SMS). The identifiers 206 and 208 may have been shown on the television 202 instead of the two-dimensional bar code.

When the user 110 “texts” the identifiers 206 and 208 to the payment server computer 131, the SMS module 132D identifies the mobile device 120 via the phone number associated with the incoming text message (SMS), and verifies that the mobile device 120 is associated with a valid account from which a payment may be made. Thereafter, the SMS module 132D associates the identifier(s) received via the text message with a merchandise and/or a merchant. In the example shown in FIG. 18, the SMS module 132D determines the merchandise ID 206 and the merchant ID 208 are associated with a digital camera (shown in FIG. 17). The SMS module 132D sends a reply message which may include the description of the merchandise and its price, and requests that the user 110 confirm the transaction. As shown in the example of FIG. 18, user 110 sends a confirmation, and the SMS module 132D sends an approval along with a reference number.

Similar to the example shown in FIG. 17, the payment server computer 131 communicates with the merchant 130 and provide the shipping information of the user 110 for the shipping of the purchased merchandise.

It can be appreciated that the embodiments of the invention provide many advantages. Embodiments of the invention may be advantageously used to allow the users to securely purchase goods and services from the merchants without disclosing the user's account information associated with account data of the user to the merchants. Embodiments of the invention are particularly useful and advantageous for mobile and seasonal merchants that users may not be comfortable with to disclose their account information. Furthermore, the embodiments of the invention advantageously allow the merchants to accept credit/debit cards without having to lease or purchase Point of Sale (POS) devices. Further technical advantages include an increase in the speed of transactions as compared to conventional payment transactions.

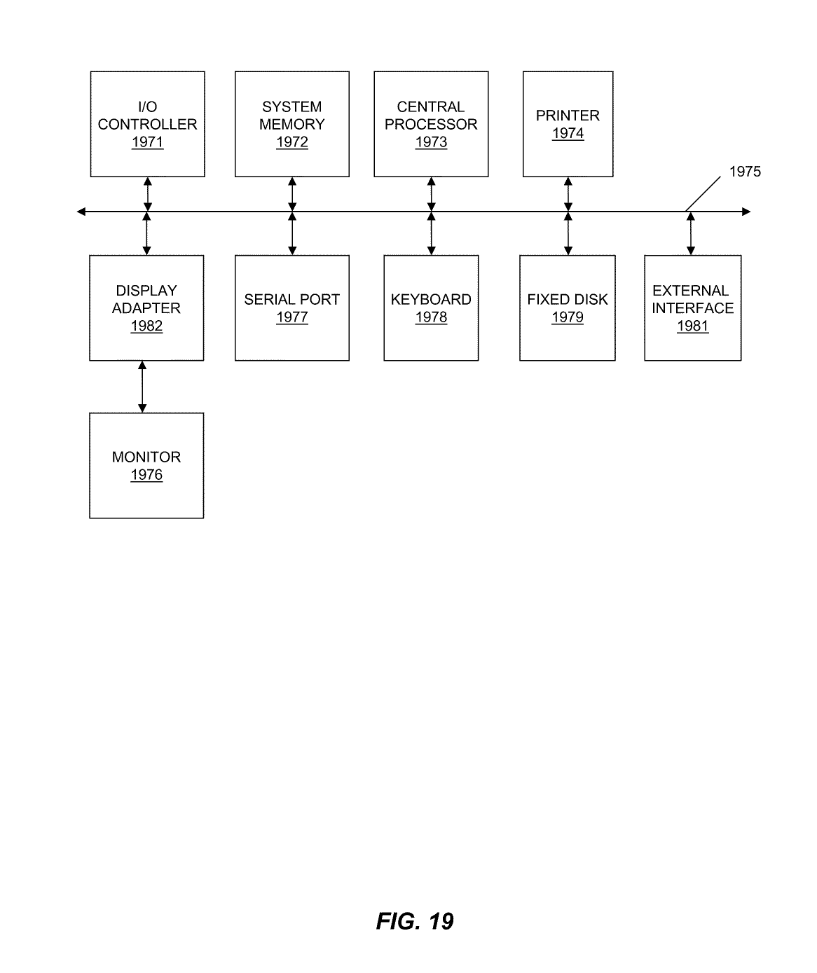

The various participants and elements of the system shown in FIGS. 1 and 2 may operate one or more computer apparatuses to facilitate the functions described herein. Any of the elements in FIGS. 1 and 2 may use any suitable number of subsystems to facilitate the functions described herein. Examples of such subsystems or components are shown in FIG. 19. The subsystems shown in FIG. 19 are interconnected via a system bus 1975. Additional subsystems such as a printer 1974, keyboard 1978, fixed disk 1979 (or other memory comprising computer readable media), monitor 1976, which is coupled to display adapter 1982, and others are shown. Peripherals and input/output (I/O) devices, which couple to I/O controller 1971, can be connected to the computer system by any number of means known in the art, such as serial port 1977. For example, serial port 1977 or external interface 1981 can be used to connect the computer apparatus to a wide area network such as the Internet, a mouse input device, or a scanner. The interconnection via system bus allows the central processor 1973 to communicate with each subsystem and to control the execution of instructions from system memory 1972 or the fixed disk 1979, as well as the exchange of information between subsystems. The system memory 1972 and/or the fixed disk 1979 may embody a computer readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Embodiments of the present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A mobile device associated with a user, the mobile device comprising:
a processor;
a computer readable medium coupled to the processor, wherein the processor is configured to execute program code stored on the computer readable medium to implement a method comprising:
receiving an identifier at the mobile device at a first location in a purchase transaction conducted with a merchant;
communicating with a remote payment server computer at a second location using the mobile device of the user;
providing the identifier to the remote payment server computer; and
initiating a payment transaction by the server computer.

2. The mobile device of claim 1, wherein in the payment transaction, the user does not provide any account information to the merchant.

3. The mobile device of claim 1, wherein the identifier is associated with merchandise.

4. The mobile device of claim 1, wherein the identifier is associated with a service.

5. The mobile device of claim 1, wherein the identifier is in the form of computer-readable data stored in a near-field enabled merchandise identifier element.

6. The mobile device of claim 5, wherein the merchandise identifier element stores a merchant ID and a merchandise ID.

7. The mobile device of claim 5, wherein the mobile device is coupled to a near-field communication device capable of near-field communication with the merchandise identifier element.

8. The mobile device of claim 5, wherein the merchandise identifier element is coupled to merchandise.

9. The mobile device of claim 1, wherein the identifier is in the form of human-readable data displayed on a merchandise identifier element coupled to merchandise, wherein the identifier includes a merchant ID and a merchandise ID.

10. The mobile device of claim 1, wherein the identifier is one or more numeric or alpha-numeric strings used to identify a particular piece of merchandise associated with a particular merchant.

11. The mobile device of claim 1, wherein the identifier is shown as an image on a television display.

12. The mobile device of claim 1, wherein using the identifier, the mobile device is capable of accessing a catalog including a virtual equivalent of one or more merchandise associated with the merchant.

13. The mobile device of claim 1, wherein upon receipt of the identifier the mobile device automatically communicates with the remote payment server computer.

14. The mobile device of claim 1, wherein the first location is the merchant's store.

15. The mobile device of claim 1, wherein the mobile device communicates with the remote payment server computer using a web browser.

16. The mobile device of claim 1, wherein the mobile device communicates with the remote payment server computer using a mobile application.

17. The mobile device of claim 1, wherein the mobile device communicates with the remote payment server computer using text message.

18. The mobile device of claim 1, wherein the payment transaction is initiated by a payment application.

19. The mobile device of claim 1, wherein a notification is received in the mobile device from the remote payment server computer upon completion of the payment transaction.

20. A method comprising:
receiving an identifier at a mobile device of a user at a first location in a purchase transaction conducted with a merchant;
communicating with a remote payment server computer at a second location using the mobile device of the user;
providing the identifier to the remote payment server computer; and
initiating a payment transaction by the server computer.

21. The method of claim 20, wherein the identifier is in the form of computer-readable data stored in a near-field enabled merchandise identifier element.

22. The method of claim 20, wherein the identifier is one or more numeric or alpha-numeric strings used to identify a particular merchandise associated with a particular merchant.

23. The method of claim 20, wherein the identifier is shown as an image on a television display.

24. The method of claim 20, wherein using the identifier, the mobile device is capable of accessing a catalog including a virtual equivalent of one or more merchandise associated with the merchant.

25. The method of claim 20, wherein the mobile device communicates with the remote payment server computer using a web browser.

26. The method of claim 20, wherein the mobile device communicates with the remote payment server computer using a mobile application.

27. The method of claim 20, wherein the mobile device communicates with the remote payment server computer using text message.

28. A method comprising:
receiving an identifier from a mobile device of a user, wherein the identifier was provided by a merchant to the user;
identifying a recipient of a payment using the identifier;
performing a payment transaction on behalf of the recipient of the payment; and
notifying the recipient of the payment that a payment has been made.

29. The method of claim 28, wherein in the payment transaction the user does not provide any account information associated with the account data of the user to the merchant.

30. The method of claim 28, wherein the merchant is the recipient of the payment.

31. The method of claim 28, wherein the identifier is in the form of computer-readable data stored in a near-field enabled merchandise identifier element.

32. The method of claim 28, wherein identifier is one or more numeric or alpha-numeric strings used to identify a particular merchandise associated with a particular merchant.

33. The method of claim 28, wherein the identifier is part of a digital image received from the mobile device.

34. The method of claim 28, wherein performing the payment transaction further comprises:
generating an authorization request message for a payment associated with an account of the user;
sending the authorization request message to an acquirer; and
receiving an authorization response message from the acquirer.

35. The method of claim 34, wherein the authorization response message is generated by an issuer associated with an account of the user.

36. A computer readable medium comprising code, executable by a processor, for implementing the method according to claim 28.

37. A server computer comprising the processor and the computer readable medium of claim 36.

38. A method comprising:
providing an identifier to a user;
receiving from a remote payment server computer a notification that a payment has been made by the user, wherein the payment was associated with merchandise or a service associated with the identifier; and
presenting the merchandise or service for which the payment was made to the user.

39. The method of claim 38, wherein the identifier is associated with a merchant.

40. The method of claim 38, wherein the identifier is readably presented as on a merchandise identifier element coupled to a merchandise.

41. The method of claim 38, wherein no account information is received from the user.

42. The method of claim 38, wherein no account information associated with the user is received from the remote payment server computer.

43. A computer readable medium comprising code, executable by a processor, for implementing the method according to claim 38.

44. A merchant computer apparatus comprising the processor and the computer readable medium of claim 43.
